(19) United States
(12) Patent Application Publication
(10) Pub. No.: US 2026/0014529 A1
(43) Pub. Date: Jan. 15, 2026

(54) MEMBRANE SEPARATION OF EMULSIONS PRODUCED FROM HYDROCARBON RECOVERY PROCESS

(71) Applicant: THE TEXAS A&M UNIVERSITY SYSTEM, COLLEGE STATION, TX (US)

(72) Inventors: SARBAJIT BANERJEE, COLLEGE STATION, TX (US); NATALIA RIVERA-GONZALEZ, CIDRA (PR); AAYUSHI BAJPAYEE, COLLEGE STATION, TX (US); MUKUL BHATIA, SUGARLAND, TX (US)

(21) Appl. No.: 18/993,918

(22) PCT Filed: Jul. 13, 2022
(86) PCT No.: PCT/US2022/036884

§ 371 Date: Jan. 13, 2025

(51) Int. Cl. B01D 71/04; B01D 17/04; B01D 67/00; C02F 1/40; C02F 1/44; C02F 101/32; C02F 103/10; C04B 28/06; C04B 111/00

(52) U.S. Cl. CPC B01D 71/04; B01D 17/045; B01D 67/0051; C02F 1/40; C02F 1/44; C04B 28/065; C02F 2101/32; C02F 2103/10; C04B 2111/00801

(57) ABSTRACT

The disclosed invention provides a hierarchically textured cement-based membrane exhibiting orthogonal wettability, specifically, superhydrophilic and underwater superoleophobic characteristics. In one embodiment, in situ formation of ettringite needles accompanied by embedding of solid impermeable structures such as cubes, cuboids, prisms, pyramids, platonic solids, torus, cone, cylinder, spheres or mixtures thereof, such as glass spheres, imbues micron- and nanoscale texturation to mesh membranes, such as stainless steel mesh membranes and provides for the separation of silt and oil from produced water at high flux rates (1600 L/h·m2). Oil concentration can be reduced as low as 1 ppb with an overall separation efficiency of 99.7% in single-pass filtration.

### FIELD OF THE INVENTION

The present disclosure relates to the separation of contaminants from produced water streams that arise from oil production.

### BACKGROUND OF THE INVENTION

Oil production, for example in the Permian Basin which extends across parts of Texas and New Mexico, is critical to the energy security of the United States but gives rise to large volumes of produced water (PW). Produced water streams contain contaminants such as silt, emulsified oil and grease, endogenous surfactants, dissolved salts, and additives used for enhanced oil recovery. Alleviating the emerging water scarcity issues across semi-arid regions has emerged as a major societal need that is central to the future of the energy industry, both domestically in the United States and abroad. There is intense interest in the design of membrane modules as sustainable and energy-efficient alternatives for produced water treatment to enable reuse of produced water for agricultural applications, safe injection into aquifers, and redeployment in enhanced oil recovery. Such membranes must meet a stringent set of criteria, from being capable of handling large volumes of produced water with high efficacy of contaminant separation to being manufacturable at large scales commensurate with the millions of barrels of produced water that needs to be cleaned.

This disclosure provides a hierarchically textured cement-based membrane exhibiting orthogonal wettability, specifically, superhydrophilic and underwater superoleophobic characteristics. In one embodiment, in situ formation of ettringite needles accompanied by embedding of solid impermeable structures such as cubes, cuboids, prisms, pyramids, platonic solids, torus, cone, cylinder, spheres or mixtures thereof, such as glass spheres, imbues micron- and nanoscale texturation to membranes (such as stainless steel mesh membranes), enables the separation of silt and oil from produced water at high flux rates (1600 L/h·m²). Oil concentration is reduced as low as 1 ppb with an overall separation efficiency of 99.7% in single-pass filtration. Turbidity derived from silt particles is decreased by two orders of magnitude and the disclosed membranes show outstanding mechanical resilience and retention of performance across multiple cycles.

### SUMMARY OF THE INVENTION

Oil production can give rise to large volumes of produced water (PW). Produced water streams contain contaminants such as silt, emulsified oil and grease, endogenous surfactants, dissolved salts, and additives used for enhanced oil recovery. Alleviating the emerging water scarcity issues across semi-arid regions has emerged as a major societal need. There is intense interest in the design of membrane modules as sustainable and energy-efficient alternatives for produced water treatment to enable reuse of produced water for agricultural applications, safe injection into aquifers, and redeployment in enhanced oil recovery. Such membranes must meet a stringent set of criteria, from being capable of handling large volumes of produced water with high efficacy of contaminant separation to being manufacturable at large scales commensurate with the millions of barrels of produced water that needs to be cleaned.

The disclosed invention provides a hierarchically textured cement-based membrane exhibiting orthogonal wettability, specifically, superhydrophilic and underwater superoleophobic characteristics. In one embodiment, in situ formation of ettringite needles accompanied by embedding of solid impermeable structures such as cubes, cuboids, prisms, pyramids, platonic solids, torus, cone, cylinder, spheres or mixtures thereof, such as glass spheres, imbues micron- and nanoscale texturation to mesh membranes, such as stainless steel mesh membranes and provides for the separation of silt and oil from produced water at high flux rates (1600 L/h·m²). Oil concentration is reduced as low as 1 ppb with an overall separation efficiency of 99.7% in single-pass filtration. Turbidity derived from silt particles is decreased by two orders of magnitude. As illustrated in the Examples, the membranes show outstanding mechanical resilience and performance is retained across multiple cycles. In various embodiments, different types of cements can be used to form the disclosed cement-based membranes. Non-limiting embodiments of the cements include, and are not limited to a calcium sulfoaluminate (CSA) cement, Portland cement, magnesia cements (such as magnesium carbonate cements, magnesium phosphate cements, magnesium silicate-hydrate cements, magnesium oxychloride cements, magnesium oxysulfate cements and combinations thereof), lime gypsum cement, chemically synthesized nanocement, and combinations thereof.

In one aspect of this disclosure, membrane architectures based on calcium sulfoaluminate (CSA) cement and glass spheres (GS) are used to clean PW. The disclosed membranes exhibit a combination of underwater superoleophobic and superhydrophilic character, enabling the effective separation of silt and oil. The oil concentration in filtered PW samples is reduced to several ppb (or less) in a single pass while maintaining a high flux rate approaching 1600 L/h·m². CSA is a low-cost structural material that has a fast-setting time, high early strength, and substantially reduced carbon footprint as compared to ordinary Portland cement (Zhou et al., 2006; Hargis et al., 2014). These characteristics make it viable as a membrane component that is manufacturable at scale.

According to another embodiment aspect, a membrane (also referred to as a “filter membrane” herein) is provided for separating a water and oil emulsion produced from a hydrocarbon recovery operation. The membrane includes, for example, a permeable metal substrate that is coated with calcium sulfoaluminate (CSA) cement and impermeable solid impermeable structures such as cubes, cuboids, prisms, pyramids, platonic solids, torus, cone, cylinder, spheres or mixtures thereof, such as solid spheres or glass spheres (GS).

In another aspect, a process is provided for separating a water and various contaminants in PW streams that arise in oil production. The process includes disposing a membrane that includes the permeable substrate, such as a permeable metal substrate, coated with a water permeable cement, such as CSA, and solid impermeable structures such as cubes, cuboids, prisms, pyramids, platonic solids, torus, cone, cylinder, spheres or mixtures thereof, such as glass spheres in a flow of PW. The process also includes applying the PW to the membrane to produce a purified water fraction with significantly reduced levels of contaminants, such as solid particulates (silt) and/or hydrocarbons or oil contaminants contained within the PW. According to yet another aspect, there is provided a method of producing a membrane for separating contaminants and water that is found in produced water. Other aspects and features of the present disclosure will become apparent to those of ordinary skill in the art upon review of the following description of specific embodiments in conjunction with the accompanying figures.

### BRIEF DESCRIPTION OF THE DRAWINGS

FIG. 1: Schematic depiction of the synthetic approach for fabrication of CSA-based membranes. CSA cement and glass sphere particles are spray-coated onto stainless steel meshes with micrometer-sized pores (5 μm), followed by the hydration of CSA cement through the immersion of the membrane architecture in water to initiate and enhance the extent of crosslinking at the surface of the membrane. This process yields an underwater superoleophobic/superhydrophilic surface. The hydration process of CSA cement delivers hexacalcium aluminate trisulfate hydrate or “ettringite” as the primary phase. After 24 h, well-defined needles of “ettringite” are formed.

FIG. 2: Representative SEM images depicting CSA/glass-bead-coated membranes with different proportions of CSA to glass sphere and varying surfaces thicknesses.

(Panel A) Stainless-steel mesh with 5 μm pore edge; (Panel B) SiO₂ particles; (Panel C) microstructure of hydrated CSA without addition of glass beads; (Panels D-E) CSA/GS membranes with a 1:1 (w/w) CSA/GS loading totaling 5 mg/cm²; (Panel F) cross-sectional view of membrane with 5 mg/cm² of 1:1 (w/w) CSA/GS loading at a thickness of 55±10 μm; (Panels G-H) CSA/GS membrane with a 2:1 (w/w) ratio totaling a loading of 10 mg/cm²; (Panel I) cross-sectional view of membrane with 10 mg/cm² of 2:1 (w/w) CSA/GS loading at a thickness of 102±9 μm; (Panels J-K) CSA/GS membrane with a 4:1 (w/w) loading totaling 20 mg/cm²; (Panel L) cross-sectional view of a membrane with 20 mg/cm² of 4:1 (w/w) CSA/GS loading at a thickness of 207±35 μm.

FIGS. 3A-3E. Wettability of CSA-based membranes, powder X-ray diffraction pattern (XRD), and X-ray Absorption Near Edge Structure (XANES) Characterization.

FIG. 3A: Powder XRD patterns collected for CSA cement during hydration, with major refined phases indicated by tick marks. The pattern for the unreacted sample is labeled “CSA”. Patterns for samples after hydration lasting from 0 min (initial) to 24 h are shown from bottom to top, with a prominent (214) reflection for an Ettringite phase clearly evident after approximately 1 h of hydration. (Inset: crystal structure of ettringite)

FIG. 3B: Normalized Ca L-edge XANES spectra for CaO and ettringite samples.

FIG. 3C: Normalized O K-edge XANES spectra for CaO, Al₂(SO₄)₃, and ettringite samples.

FIG. 3D: Underwater contact angle of synthetic engine oil on bare stainless-steel mesh.

FIG. 3E: Underwater contact angle of synthetic engine oil on CSA/glass-sphere-coated membrane.

FIG. 4: Gas chromatography-mass spectrometry (GC-MS) analysis of PW and filtered streams collected for CSA/GS-coated membranes. Comparison of GC-MS for produced water, and CSA/GS-coated stainless-steel mesh membranes: (1) loading of 5 mg/cm² at a CSA/GS ratio of 1:1; (2) loading of 10 mg/cm² at a CSA/GS ratio of 2:1; and (3) loading of 20 mg/cm² at a CSA/GS ratio of 4:1.

FIGS. 5A-5B: Evaluation of membrane performance across design space of weight ratio of CSA:glass spheres, coating thickness, and flux rate. (FIG. 5A) Flux-rate-dependent GC-MS results for PW from Well 9 considering rates from 1600-8000 L/h·m² (using a CSA/glass-sphere-coated membrane with the loading of 20 mg/cm² at a CSA/GS ratio of 4:1) (FIG. 5B) 3D plot of total separation efficiency considering all aliphatic hydrocarbons present in filtered water as a function of CSA/GS loading (in mg/cm²) and the ratio of CSA/GS and flux rate (1600-8000 L/h·m²). Coating thicknesses ranging from 55±10 μm to 207±35 μm and loading from 5-20 mg/cm² were evaluated.

FIGS. 6A-6E: Evaluation of Membrane Module with an Optimal CSA/GS Coating.

FIG. 6A: Optical microscopy image of PW emulsion from Well 9.

FIG. 6B: Optical microscopy image of filtered water recovered from optimal membrane module (CSA/GS ratio of 4:1, CSA/GS loading of 20 mg/cm²).

FIG. 6C: GC-MS showing the aliphatic hydrocarbons present in the PW emulsion from Well 9 and the corresponding chromatogram for filtered water collected from the membrane module.

FIG. 6D: Particle size analysis for PW from well 9 in the Permian Basin and filtered water recovered after separation. The digital photograph illustrates the visual change

FIG. 6E: The separation efficiency of the CSA-based membrane determined by the oil concentration after 10 separation cycles and backwash.

FIG. 7: Schematic depiction of a membrane assembly/module.

FIGS. 8A-8D show digital photographs of CSA/GS membrane. FIG. 8A) pristine membrane hydrated for 24 h; FIG. 8B) membrane after filtration of 500 mL of PW; FIG. 8C) membrane after backwash with 50 mL water after first separation cycle; and FIG. 8D) membrane after backwash with 50 mL water after 10^{th} separation cycle.

FIG. 9 shows calibration curves for the primary oil fractions in Well 9 ranging from C13-C23 and corresponding linear fits. Calibration curves were determined using a C8-C40 Alkane Calibration Standard in dichloromethane. Concentrations prepared range from 0.25-50 ng/mL.

FIGS. 10A-10C: 3D plots for turbidity measurements measured for membranes as a function of CSA/GS loading and flux rate. Different CSA/GS weight ratios have been evaluated: (FIG. 10A) 4:1; (FIG. 10B) 2:1; (FIG. 10C) 1:1.

FIGS. 11A-11B: Metric optimization of CSA-based membranes for destabilization of PW emulsions from the Permian Basin. (FIG. 11A) The 3D plot of turbidity of filtered water as a function of the ratio of CSA/GS and flux rate (1600-8000 L/h·m²) (using a CSA/GS loading of 20 mg/cm² and thickness of 207±35 μm) (FIG. 11B) The 3D plot of oil concentration (in ppb) for filtered water as a function of the ratio of CSA/GS and CSA/GS loading (in mg/cm²). The concentration of oil highlighted is from C20, one of the most dominant fractions throughout the water samples.

FIG. 12: List of well in the Permian Basin, formations, and a representative digital photograph of the produced water. The CSA/glass sphere-coated membrane with a 4:1 weight ratio, loading totaling 20 mg/cm², and thickness of 207±35 μm was utilized for this separation analysis. The filtration membrane cell was run at 1600 L/h·m². These membrane characteristics were applied for the separation of PW emulsion for wells 1-14.

### DETAILED DESCRIPTION OF THE INVENTION

It will be appreciated that for simplicity and clarity of illustration, where considered appropriate, reference numerals may be repeated among the figures to indicate corresponding or analogous elements. In addition, numerous specific details are set forth in order to provide a thorough understanding of the embodiments described herein. However, it will be understood by those of ordinary skill in the art that the embodiments described herein may be practiced without these specific details. In other instances, well-known methods, procedures and components have not been described in detail so as not to obscure the embodiments described herein. Also, the description is not to be considered as limiting the scope of the embodiments described herein.

As used herein, the singular forms “a”, “an” and “the” are intended to include the plural forms as well, unless the context clearly indicates otherwise. Further, to the extent that the terms “including”, “includes”, “having”, “has”, “with”, or variants thereof are used in either the detailed description and/or the claims, such terms are intended to be inclusive in a manner similar to the term “comprising”. The term “and/or” used in a phrase such as “A and/or B” herein is intended to include “A and B”, “A or B”, “A”, and “B”.

The transitional terms/phrases (and any grammatical variations thereof) “comprising”, “comprises”, “comprise”, include the phrases “consisting essentially of”, “consists essentially of”, “consisting”, and “consists” have their recognized meaning and can be used interchangeably throughout this disclosure and the claims.

The phrases “consisting essentially of” or “consists essentially of” indicate that the claim encompasses embodiments containing the specified materials or steps and those that do not materially affect the basic and novel characteristic(s) of the claim.

The term “about” or “approximately” means within an acceptable error range for the particular value. The terms “about” or “approximately” can mean a range of up to 0-20%, 0 to 10%, 0 to 5%, or up to 1% of a given value. In certain embodiments, the terms “about” and “approximately” provide for a variation (error range) of 0-10% around the stated value (X±10%).

In the present disclosure, ranges are stated in shorthand, so as to avoid having to set out at length and describe each and every value within the range. Any appropriate value within the range can be selected, where appropriate, as the upper value, lower value, or the terminus of the range. For example, a range of 0.1-1.0 represents the terminal values of 0.1 and 1.0, as well as the intermediate values of 0.2, 0.3, 0.4, 0.5, 0.6, 0.7, 0.8, 0.9, and all intermediate ranges encompassed within 0.1-1.0, such as 0.2-0.5, 0.2-0.8, 0.7-1.0, etc.

“Produced water” (PW) is water that comes out of an oil well with crude oil during crude oil production. Produced water contains soluble and non-soluble oil/organics, suspended solids (e.g., silt), dissolved solids, and various chemicals used in the production process.

The present disclosure provides a membrane (filter membrane) for separating water, solid particulates and other contaminants, such as oil from PW. The membrane includes a permeable substrate, in some embodiments a permeable metal substrate, that is coated with a water permeable cement, such as a calcium sulfoaluminate (CSA) cement that, optionally, contains solid impermeable structures such as cubes, cuboids, prisms, pyramids, platonic solids, torus, cone, cylinder, spheres or mixtures thereof. In certain embodiments, the solid impermeable structures are solid impermeable spherical structures, such as glass spheres (GS). As discussed above, various cements can be used for coating the permeable substrate. Non-limiting examples of such cements include calcium sulfoaluminate (CSA) cement, magnesia cements (such as magnesium carbonate cements, magnesium phosphate cements, magnesium silicate-hydrate cements, magnesium oxychloride cements, magnesium oxysulfate cements and combination thereof (see, for example, Magnesia Cements: From Formulation to Application, Mark A. Shand et al., 2020, Elsevier, Cambridge, MA or Magnesia-based Cements: A Journey of 150 Years, and Cements for the Future, Sam A. Walling and John L. Provis, 2016, Chemical Reviews, 116(7):4170-4204, the disclosures of which are hereby incorporated by reference in its entirety), lime gypsum cement, chemically synthesized nanocement, and combinations thereof.

The membrane can be used to separating water and various contaminants found in PW based on the differential wettability of the two liquids on the textured surface. The permeable substrate may be any substrate that is permeable to water, for example, fabrics, including, but not limited to cotton fabrics, polyester fabrics, denim fabrics, denim, crinoline, elastane or spandex (e.g., LYCRA), viscose, linen, and combinations thereof, Al₂O₃, cellulose fibers, a metal or metal oxide substrate, a ceramic, a sintered metal, or a metal mesh. In embodiments where the permeable metal substrate is a metal mesh substrate, it can be composed of stainless steel, aluminum, brass, bronze, copper, polytetrafluoroethylene coated stainless steel, galvanized low alloy steel, nickel-coated low alloy steel, or an acid-resistant nickel. Metal oxides suitable for use as a substrate include, and are not limited to, one or more of ZnO, Al₂O₃, MgO, Fe₂O₃, Fe₃O₄, SiO₂, TiO₂, V₂O₅, ZrO₂, HfO₂, MoO₃, or WO₃ and combinations thereof. The mesh substrate may have a pore size of between about 0.1 μm and about 1000 μm. In some embodiments the mesh substrate can have a pore size of: between about 0.1 μm and about 900 μm; between about 0.1 μm and about 800 μm; between about 0.1 μm and about 700 μm; between about 0.1 μm and about 600 μm; between about 0.1 μm and about 500 μm; between about 0.1 μm and about 400 μm; between about 0.1 μm and about 300 μm; between about 0.1 μm and about 200 μm; between about 0.1 μm and about 100 μm; between about 0.1 μm and about 50 μm; between about 0.1 μm and about 25 μm; between about 0.1 μm and about 20 μm between about 0.1 μm and about 15 μm; between about 0.1 μm and about 10 μm; or between about 0.1 μm and about 5 μm.

In other embodiments, the permeable substrate (e.g., a mesh substrate, such as a metal mesh) may have a pore size of between about 1 μm and about 1000 μm. Thus, in various embodiments, the mesh substrate can have a pore size of: between about 1 μm and about 900 μm; between about 1 μm and about 800 μm; between about 1 μm and about 700 μm; between about 1 μm and about 600 μm; between about 1 μm and about 500 μm; between about 1 μm and about 400 μm; between about 1 μm and about 300 μm; between about 1 μm and about 200 μm; between about 1 μm and about 100 μm; between about 1 μm and about 50 μm; between about 1 μm and about 25 μm; between about 1 μm and about 20 μm between about 1 μm and about 15 μm; between about 1 μm and about 10 μm; or between about 1 μm and about 5 μm.

In yet other embodiments, the permeable substrate (e.g., a mesh substrate, such as a metal mesh) may have a pore size of between about 5 μm and about 500 μm. Thus, in various embodiments, the mesh substrate can have a pore size of: between about 5 μm and about 400 μm; between about 5 μm and about 300 μm; between about 5 μm and about 200 μm; between about 5 μm and about 100 μm; between about 5 μm and about 50 μm; between about 5 μm and about 25 μm; between about 5 μm and about 20 μm between about 5 μm and about 15 μm; or between about 5 μm and about 10 μm.

The permeable membrane may be coated with a hydrophilic cement (water permeable cement), such as a CSA cement or Portland cement (any type as specified in ASTM C150/C150M-21, web site: blog.ansi.org/portland-cement-types-specifications-astm-c150/#gref) that is, optionally, mixed with solid structures as described herein. In various embodiments, the water permeable cement can comprise or be selected from a CSA cement, Portland cement, a magnesia cement (such as magnesium carbonate cements, magnesium phosphate cements, magnesium silicate-hydrate cements, magnesium oxychloride cements, magnesium oxysulfate cements and combinations thereof), lime gypsum cement, chemically synthesized nanocement, and various combinations thereof. Each cement can be used alone, or in combination with one or more of additional cement for coating the permeable membrane. The water permeable cement, optionally containing solid structures, can have a thickness between about 50 μm and about 1000 μm. In some embodiments, the cement, optionally containing solid structures, has a thickness between: between about 50 μm and about 900 μm; between about 50 μm and about 800 μm; between about 50 μm and about 700 μm; between about 50 μm and about 600 μm; between about 50 μm and about 500 μm; between about 50 μm and about 400 μm; between about 50 μm and about 300 μm; between about 50 μm and about 200 μm; between about 50 μm and about 250 μm; between about 50 μm and about 275 μm; between about 50 μm and about 100 μm; between about 150 μm and about 350 μm; between about 150 μm and about 250 μm; between about 200 μm and about 500 μm between about 200 μm and about 350 μm; between about 200 μm and about 400 μm; between about 200 μm and about 300 μm; between about 175 μm and about 250 μm; or between about 100 μm and about 500 μm. The permeable membrane can also be coated with the cement or cement/solid structure composition in amounts that range between: about 5 mg/cm² to about 500 mg/cm²; about 5 mg/cm² to about 400 mg/cm²; about 5 mg/cm² to about 300 mg/cm²; about 5 mg/cm² to about 200 mg/cm²; about 5 mg/cm² to about 100 mg/cm²; about 5 mg/cm² to about 75 mg/cm²; about 5 mg/cm² to about 50 mg/cm²; about 5 mg/cm² to about 25 mg/cm²; about 10 mg/cm² to about 500 mg/cm²; about 10 mg/cm² to about 400 mg/cm²; about 10 mg/cm² to about 300 mg/cm²; about 10 mg/cm² to about 200 mg/cm²; about 10 mg/cm² to about 100 mg/cm²; about 10 mg/cm² to about 75 mg/cm²; about 10 mg/cm² to about 50 mg/cm²; about 10 mg/cm² to about 25 mg/cm²; or about 20 mg/cm².

As discussed above, the cement coating can contain, embedded within the surface of the cement, solid impermeable spheres, such as glass spheres. The cement and solid impermeable structures can be combined at a weight ratio of cement to solid structures of about 1:1, about 2:1, about 3:1, about 4:1 or about 5:1. The spheres used to embed the cement coating can have a diameter of between about 5 μm and about 50 μm; between about 5 μm and about 40 μm; between about 5 μm and about 30 μm; between about 5 μm and about 20 μm; between about 5 μm and about 15 μm; between about 5 μm and about 10 μm; between about 9 μm and about 15 μm; or between about 9 μm and about 13 μm. In certain embodiments, the cement forms needle-like structures of hexacalcium aluminate trisulfate hydrate or “ettringite” as the primary phase. In other embodiments, the cement coating comprise solid impermeable structures selected from cubes, cuboids, prisms, pyramids, platonic solids, torus, cone, cylinder, spheres and mixtures thereof that are embedded within the surface of the cement. The solid impermeable structures can be manufactured from any water impermeable substance, such as cellulose, glass, plastics or polymers (,such as polyvinylidene fluoride (PVDF), polyethylenimine (PEI), polyethylene terephthalate (PET), or polyethylene) acrylics, metals, ceramics (such as ZrO₂, Al₂O₃, TiO₂, SiO₂, or HfO₂) or mixtures thereof. In any of these embodiments, the solid impermeable structures have at least one dimension (length, width, diameter, and/or height) that is between about 5 μm and about 50 μm; between about 5 μm and about 40 μm; between about 5 μm and about 30 μm; between about 5 μm and about 20 μm; between about 5 μm and about 15 μm; between about 5 μm and about 10 μm; between about 9 μm and about 15 μm; or between about 9 μm and about 13 μm. As discussed above, the surface of the cement preferably exhibits 3D texturation and tortuosity that is caused by the embedded solid impermeable structures and/or the needle-like structures of hexacalcium aluminate trisulfate hydrate or “ettringite”. The impermeable structures discussed herein may also have a porosity in the nanometer range.

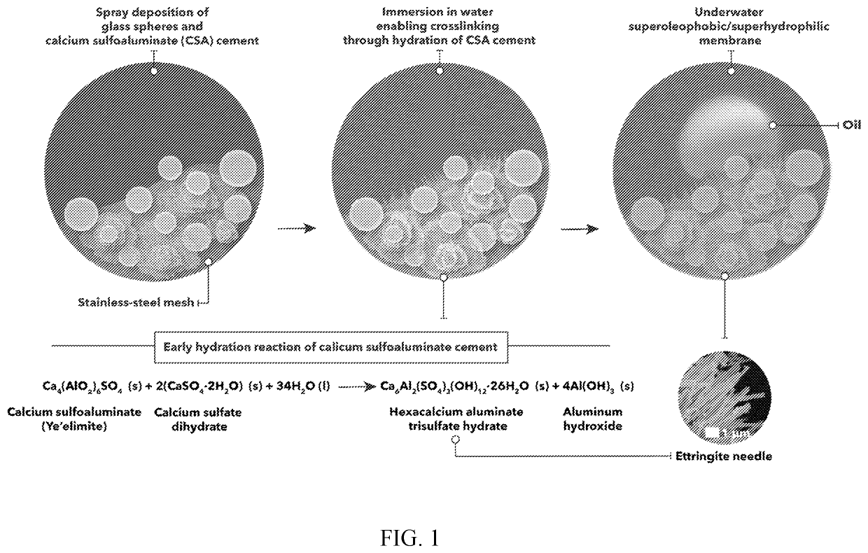

FIG. 1 illustrates an exemplary method of producing a membrane as disclosed herein. As illustrated in FIG. 1, CSA cement and glass sphere particles are spray-coated onto stainless steel mesh with micrometer-sized pores (5 μm), followed by the hydration of CSA cement through the immersion of the membrane architecture in water to initiate and enhance the extent of crosslinking at the surface of the membrane. This process yields an underwater superoleophobic/superhydrophilic surface. The hydration process of CSA cement delivers hexacalcium aluminate trisulfate hydrate or “ettringite” as the primary phase. After 24 hours, well-defined needles of “ettringite” are formed. In such a method, the hydration process can range from between about 0.5 hours and about 24 or about 36 hours or more (for example, from 0.5 hours to up to about: 1.5, 2, 3, 4, 5, 6, 7, 8, 9, 10, 11, 12, 13, 14, 15, 16, 17, 18, 19, 20, 21, 22, 23, 24, 25, 28, 27, or 28 days).

In another aspect of the invention, a filter assembly is provided that comprises at least one filter membrane as disclosed herein. The filter assembly comprises a filter membrane comprising a permeable substrate, in some embodiments a permeable metal substrate, that is coated with a water permeable cement, such as a calcium sulfoaluminate (CSA) cement that, optionally, contains solid impermeable structures such as cubes, cuboids, prisms, pyramids, platonic solids, torus, cone, cylinder, spheres or mixtures thereof. In some embodiments, the solid impermeable structures are glass spheres (GS). The filter assembly can, in some embodiments, comprise a vertical or horizontal stack of filter membranes. The filter assembly comprises one or more filter membrane mounted inside a rigid structure or frame, called the filter plate. The filter membrane can be sealed within the filter plates by gaskets other sealing mechanisms, such as O-rings as is illustrated in FIG. 7. The filter assembly includes inlet and outlet connectors that permit PW to enter and purified water to exit the filter assembly.

A filter membrane can be formed by coating a permeable substrate by applying a water permeable cement to the permeable substrate. As indicated above, the permeable substrate may be a metal mesh substrate, such as stainless steel, aluminum, brass, bronze, copper, polytetrafluoroethylene coated stainless steel, galvanized low alloy steel, nickel-coated low alloy steel, or an acid-resistant nickel. The cement may also include solid impermeable structures such as cubes, cuboids, prisms, pyramids, platonic solids, torus, cone, cylinder, spheres or mixtures thereof as discussed above. In certain embodiments, solid glass spheres are embedded within the cement. In some embodiments, the cement can be applied to the permeable substrate by spray coating or other suitable means. The cement can be applied to the substrate at any temperature, such as room temperature or higher temperatures (for example, between about 20° C. and about 250° C., between about 40° C. and about 250° C., between about 50° C. and about 250° C., between about 75° C. and about 250° C., between about 100° C. and about 250° C., between about 125° C. and about 250° C., between about 150° C. and about 250° C., between about 175° C. and about 250° C., between about 200° C. and about 250° C., or about 200° C. After the coated substrate has cooled, for example to room temperature, the cement coated substrate can be submerged in water to hydrate the cement for a period of 30 minutes or more (for example for up to 24, 28 or 72 hours or a period of about: 1.5, 2, 3, 4, 5, 6, 7, 8, 9, 10, 11, 12, 13, 14, 15, 16, 17, 18, 19, 20, 21, 22, 23, 24, 25, 28, 27, or 28 days). As noted above, the coated substrate be embedded with solid impermeable structures such as cubes, cuboids, prisms, pyramids, platonic solids, torus, cone, cylinder, spheres or mixtures thereof to provide 3D texturation as well as tortuosity. In some embodiments, glass spheres are used to provide 3D texturation and tortuosity. In some embodiments, the cement forms needle-like structures of hexacalcium aluminate trisulfate hydrate or “ettringite”. In various embodiments, the water permeable cement can comprise or be selected from a CSA cement, Portland cement, a magnesia cement (such as magnesium carbonate cements, magnesium phosphate cements, magnesium silicate-hydrate cements, magnesium oxychloride cements, magnesium oxysulfate cements and combinations thereof), lime gypsum cement, chemically synthesized nanocement, and various combinations thereof. Each cement can be used alone, or in combination with one or more of additional cement for coating the permeable membrane.

The described embodiments are to be considered in all respects only as illustrative and not restrictive. The scope of the claims should not be limited by the preferred embodiments set forth in the examples, but should be given the broadest interpretation consistent with the description as a whole. All changes that come with meaning and range of equivalency of the claims are to be embraced within their scope.

### Materials and Methods

### Method Details

### Materials

Reagents and their commercial sources are as follows: CSA cement (Silica Systems Inc.); Dichloromethane (DCM, EMD Millipore); ethanol—200 proof pure ethanol (Koptec); glass spheres: 9-13 μm particles, nitric acid—aqueous OmniTrace, and C8-C40 alkanes calibration standard in DCM (Millipore Sigma). All chemicals and solvents were used as received.

Membrane Design: Incorporation of CSA and glass spheres onto stainless steel mesh. The main components of the membrane architecture disclosed in the Examples include CSA, glass spheres, and stainless-steel mesh. In assembling the membrane, the CSA and glass sphere particles were dispersed in deionized water by ultrasonication (Branson Ultrasonic Bath 5510, Branson Ultrasonic Corp.) for ca. 5 min. The CSA-based dispersion was spray-coated onto a 304 stainless steel mesh (50 cm², pore size: 5 μm, McMaster-Carr) using a master airbrush (0.5 mm nozzle diameter) coupled to an air compressor with a pressure of ca. 25 psi. During the spray-coating process, the substrate was heated to 200° C. to aid water evaporation. After cooling to room temperature, the membrane was immersed in a water bath held at 25° C. for 24 h to promote hydration of CSA. Different loadings (5, 10, 15, and 20 mg/cm²) of CSA/glass spheres and weight ratios of CSA to GS (4:1, 2:1, and 1:1) were evaluated to evaluate the optimal conditions for removal of silt and oil from produced water.

Wettability of CSA-based membranes: Oil contact angles were measured using a CAM 200 Optical Goniometer. Synthetic engine oil (SAE Viscosity grade 5W-40, McMaster-Carr) and water were used to evaluate the superoleophobicity and superhydrophilicity of the membranes. For underwater oil contact angle measurements, the underwater contact angle was determined using a transparent quartz cuvette, a custom-made T-shaped steel substrate holder (304 stainless steel sheet with a size of 1 in×1 in, McMaster-Carr, alongside a stainless steel rod), and an inverted “J” stainless steel needle with a 1 mL glass syringe (Waghmare et al., 2013; Liu et al., 2016). In the sessile drop measurements, the cuvette was filled with water, and the membrane was attached to the flat surface of the steel holder, which was positioned upside down so the substrate became submerged underwater while the steel rod was fixed to the goniometer. The membrane substrate was submerged into the water using a steel holder; next, a syringe was introduced to deliver ca. 5 μL oil droplets, which floated to the top to the membrane surface. Contact angle measurements were implemented in triplicate; ImageJ was used for analysis.

Characterization of membrane architecture: The hydration of CSA was tracked by powder X-ray diffraction (XRD) using a Bruker D8 Advance Eco X-ray powder diffractometer coupled with a Lynxeye detector (25 kV, 40 mA) and a Cu Kα (λ=1.5418 Å) source. The morphology of the functionalized CSA-based membrane surface was imaged using a JEOL JSM-7500F field-emission scanning electron microscope coupled with a high brightness conical FE gun and a low-aberration conical objective lens. All samples for SEM imaging were coated with an ultra-thin platinum layer using a Cressington 208HR High-Resolution Sputter Coater.

Ca L- and O K-XANES measurements were performed at the National Synchrotron Light Source II of Brookhaven National Laboratory beamline SST-1 operated by the National Institute of Standards and Technology. Measurements were performed in partial electron yield (PEY) mode with a nominal resolution of 0.1 eV. The PEY signal was normalized to the incident beam intensity of a clean gold grid to eliminate the effects of any incident beam fluctuations and optics absorption features.

Mechanical testing of the CSA-GS coatings was implemented using ASTM D2197, where a U-shaped loop was placed to the surface and used to scrape the surface with added weights ranging from 0-300 g. These measurements provide a measure of coating adhesion. Samples for the mechanical testing were prepared on galvanized stainless-steel sheet substrates instead of membranes (6 in²).

Membrane module design: separating silt and oil from PW: The membrane module system was built with a stainless-steel filtration cell, MemXcell (Model: MX-1-SS, Molecule Works Inc., FIG. 7), and connected to a peristaltic pump (Masterflex L/S Digital Drive with Easy-Load II Pump Head, 600 RPM, Cole-Palmer) with L/S 24 tubing. In typical filtration experiments, the CSA-coated membrane (50 cm2) was positioned within the cell on the sweep plate and secured with two graphite gaskets; next, a feed flow plate was placed on the top and secured with screws. Before every run, the system was cleaned with hexanes, ethanol, powdered precision cleaner dilution (1:100 dilution, Alconox), and water (ca. 250 mL) at a flux rate of 1,600 L/h·m2. In each run, PW was flowed through the custom-designed system with the help of a peristaltic pump and the effluent stream was collected for further analysis. Flux rates ranging from 1,600 to 8,000 L/h·m2 were analyzed to establish the optimal conditions for separating silt and oil from PW.

Performance evaluation of membranes: The presence of silt in the filtrate samples compared to the produced water was studied using turbidity measurements and particle size analysis. Turbidity measurements were collected by using a 2100Q portable turbidimeter. The turbidity measurements were calibrated using a Gelex secondary standards kit (10NT, 20 NTU, 100 NTU, 800 NTU). Immediately after collecting the filtrate, the turbidity measurements were performed to avoid sedimentation; six replicates were gathered for each sample.

The particle size distribution of silt particles in filtered samples was determined using a Horiba laser scattering particle size distribution analyzer (LA-960) with a size detection capacity ranging from 10 nm to 5 mm. Ethanol (ca. 180-250 mL, 99.5%) was used as a dispersion medium. Solid solutions of each sample type were used while performing at least three replicate measurements. For each run, samples were circulated for 2 min, agitated for 2 min, followed by ultrasonication for 2 min, and alignment and blanking of the instrument.

The presence of oil and silt in PW and filtrate streams was further evaluated using an Olympus BX41 optical microscope. The collected samples were pressed between two thin glass microscope slides. The samples were illuminated using a Euromex EK-1 halogen lamp fiber optic light source.

Quantitative separation analysis: removal of silt and oil from produced water: The concentration of oil (in ppb) in PW and filtrate samples was examined by GC-MS using a Thermo Scientific DSQ II instrument. Data acquisition and processing were performed using Thermo Xcalibur software. Oil fractions ranging from C11 to C30 were detected in collected PW samples from across the Permian Basin. GC-MS samples were prepared by performing an extraction with a 6:1 (v/v) mixture of water and dichloromethane. Since water samples were collected in glass vials and oil can adhere to the glass wall of the vials, DCM was first added into the vials, and then the layers were mixed using a vortexer (Vortex-Genie 2) to collect all the oil. The two-phase mixture was then separated using a separation funnel and the decanted DCM layer was used for further analyses. Each sample was run in triplicate. FIG. 9 in the Supplemental Information plots calibration curves for the most abundant oil fractions in the PW samples (i.e., C13-C23) generated using a C8-C40 Alkanes Calibration Standard. Standard solutions were prepared with concentrations ranging from 0.25-50 ng/mL in dichloromethane.

In assessing the stability of the membrane architecture throughout the separation process, the filtration system was run for ten cycles of running forward and backward. For each backwash, ca. 10% of water (out of the water used forward) was utilized to clean the membrane and restart the process. The elemental composition of the produced water and recovered produced water was determined using inductively coupled plasma-mass spectroscopy (PerkinElmer NexION 300D ICP-MS), and data collection and processing were conducted via Syngistix v2.4. Water samples (0.5 g) were digested in a 2% aqueous solution of HNO3 and diluted to 100 ng/mL.

Determination of the overall separation efficiency for deoiling in PW and filtered water samples: In order to effectively quantify the overall efficiency of separation (ϵₜ) of oil fractions from produced water, contribution of each aliphatic fraction (Cₓ) was normalized using Equation 1. This contribution was assigned as efficiency coefficient for that fraction (eff_{C}_{ₓ}) and is characteristic of that fraction. Then, efficiency of each fraction was calculated using Equation 2. Effective efficiency of separation (includes contribution from all aliphatic fractions for a membrane composition) was calculated by summation of the product of the characteristic coefficient of efficiency for each aliphatic fraction and efficiency of that fraction (as depicted in Equation 3).

$$Coefficient of {eff}_{{C}_{x}} = \frac{Concentration of {C}_{x} in PW}{Total concentration of aliphatic fractions in PW} \qquad ( Equation 1 )$$

$${eff}_{{C}_{x}} = \frac{\begin{matrix}Concentration of {C}_{x} in PW - \\ Concentration of {C}_{x} in filtrate\end{matrix}}{Concentration of {C}_{x} in PW} \times 100 \qquad ( Equation 2 )$$

$${ϵ}_{t} = 0.218 \times {eff}_{{C}_{13}} + 0.258 \times {eff}_{{C}_{14}} + 0.171 \times {eff}_{{C}_{16}} + 0.088 \times {eff}_{{C}_{18}} + 0.084 \times {eff}_{{C}_{20}} + 0.066 \times {eff}_{{C}_{21}} + 0.063 \times {eff}_{{C}_{22}} + 0.052 \times {eff}_{{C}_{23}} \qquad ( Equation 3 )$$

Determining the efficacy of CSA without glass spheres: Since higher concentrations of CSA yielded the most efficient separation, a control experiment was performed to examine the critical role of the glass spheres in the membrane architecture. Coated membranes were prepared using CSA particles only without glass spheres. In this “control” membrane, the CSA particles (loading of 20 mg/cm2) were spray-coated at 200° C. onto a stainless-steel mesh (50 cm2), and the membrane was hydrated for 24 h. The resulting coated substrate was used within the membrane module. For each sample, 0.5 L of PW was filtered through the system. GC-MS and turbidity measurements were performed for the effluent streams to evaluate oil and silt concentrations.

### EXAMPLES

### Example 1

FIG. 1 illustrates the workflow for preparing hierarchically textured CSA-based membranes. CSA and glass spheres are sprayed onto stainless-steel mesh substrates with pore dimensions of 5 μm×5 μm; the mesh imbues micron-scale texturation and serves as a continuous support for the otherwise brittle cement thin film.

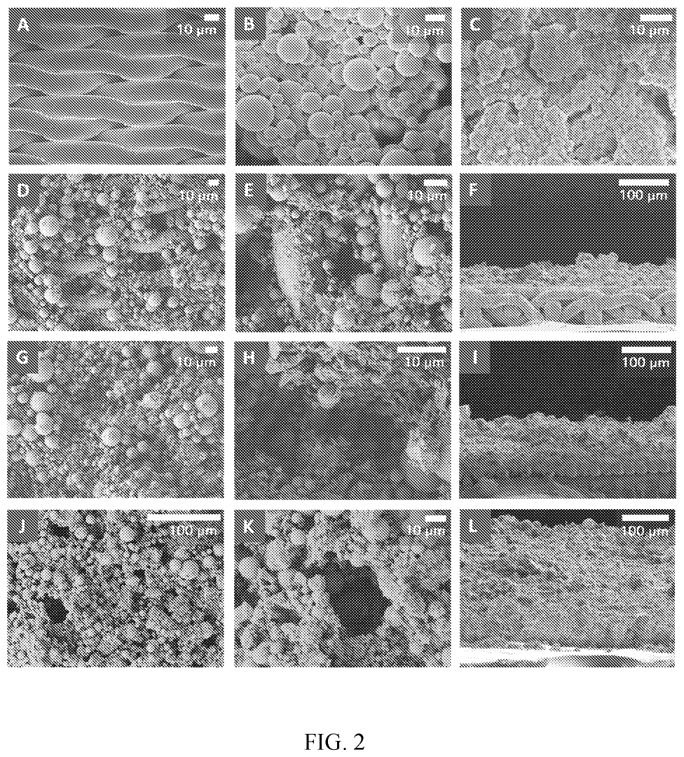

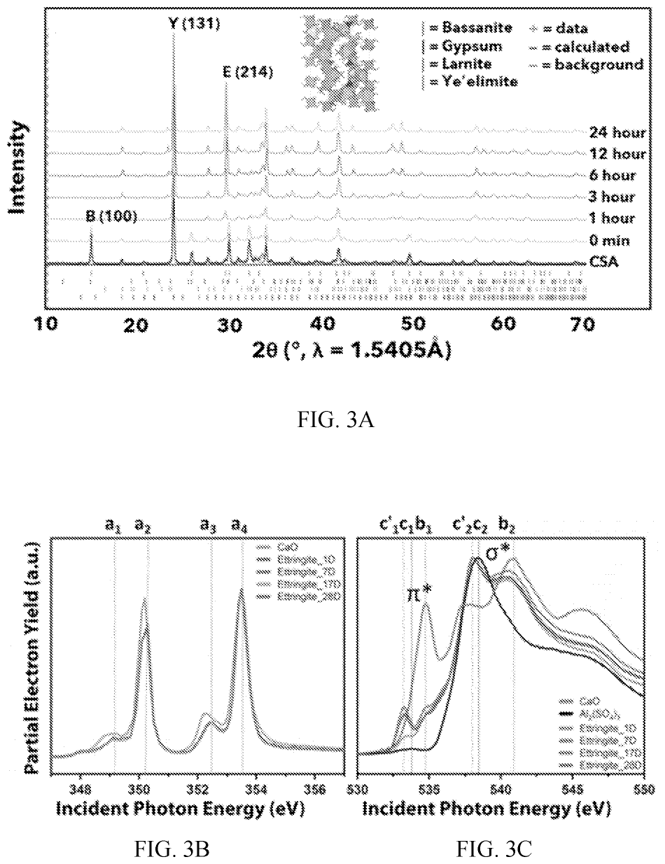

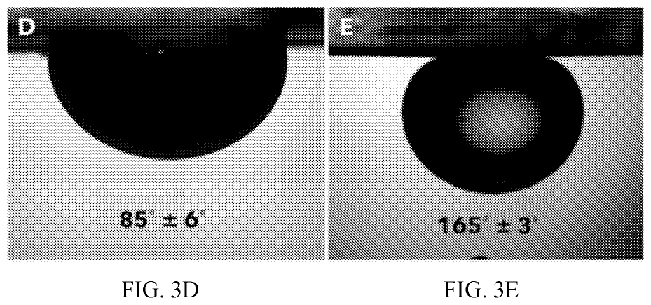

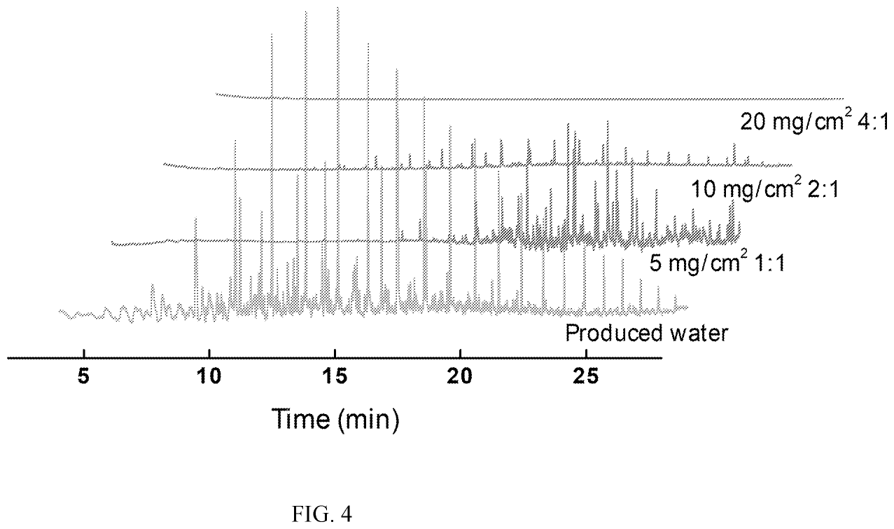

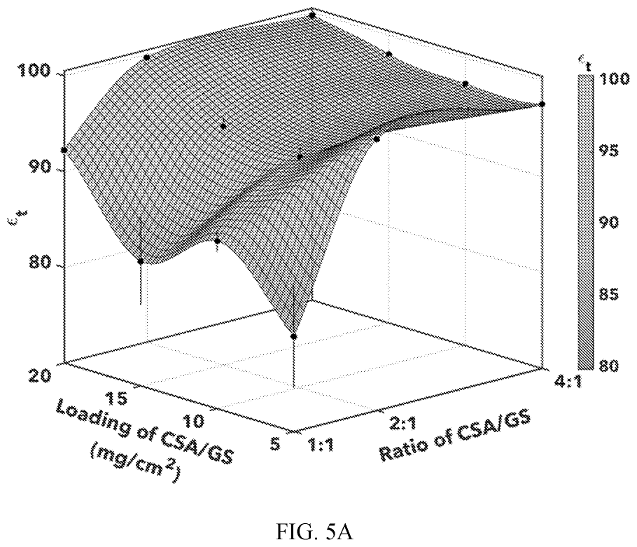

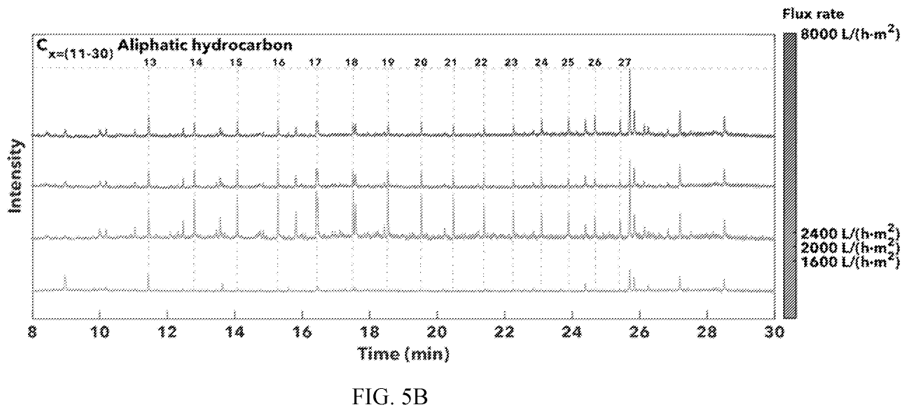

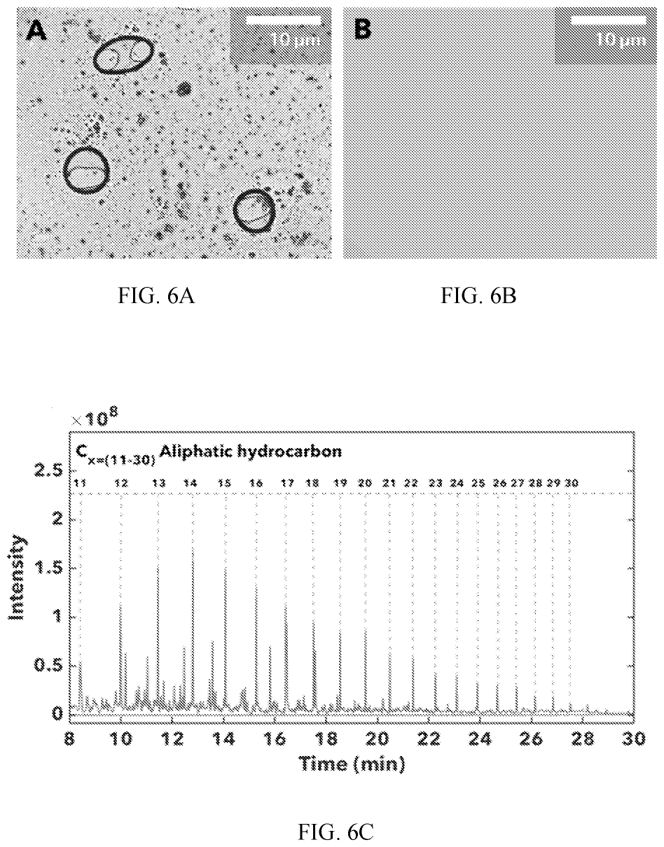

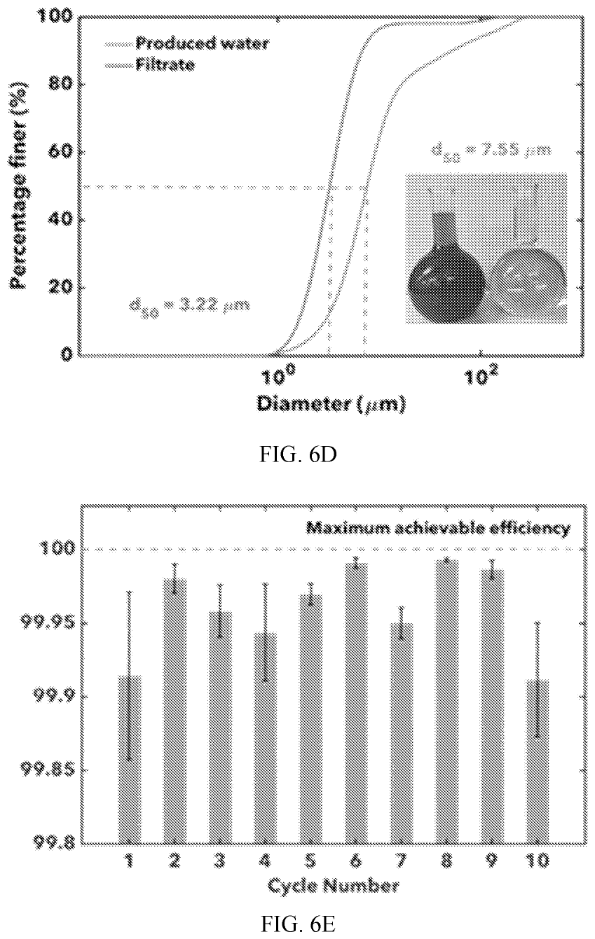

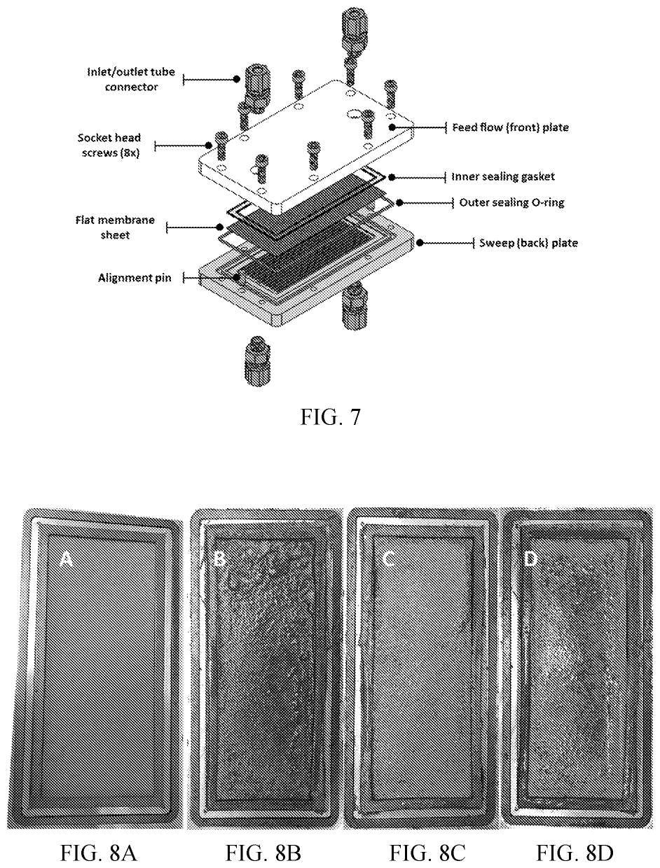

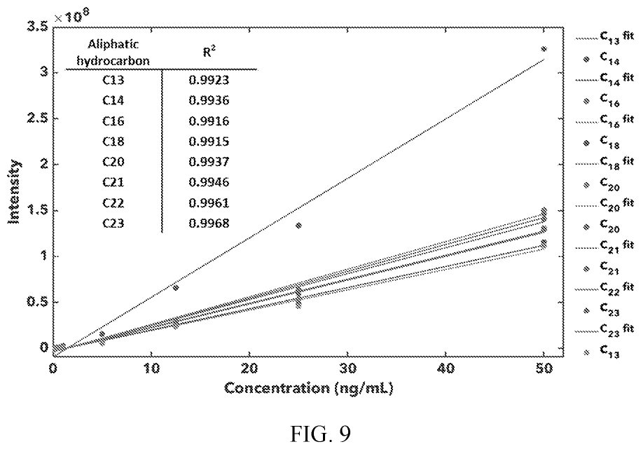

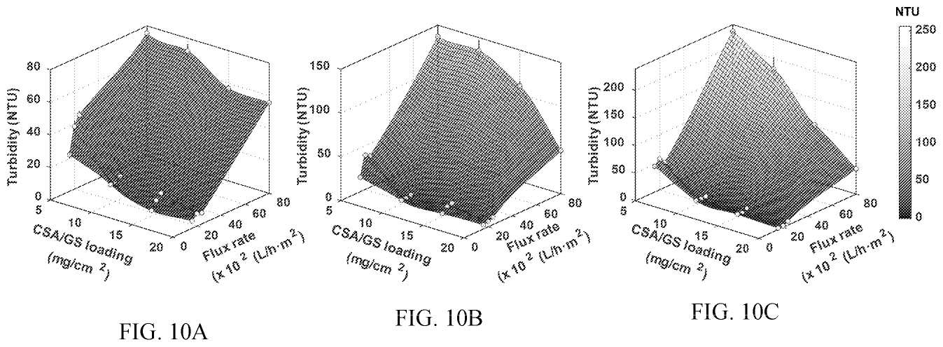

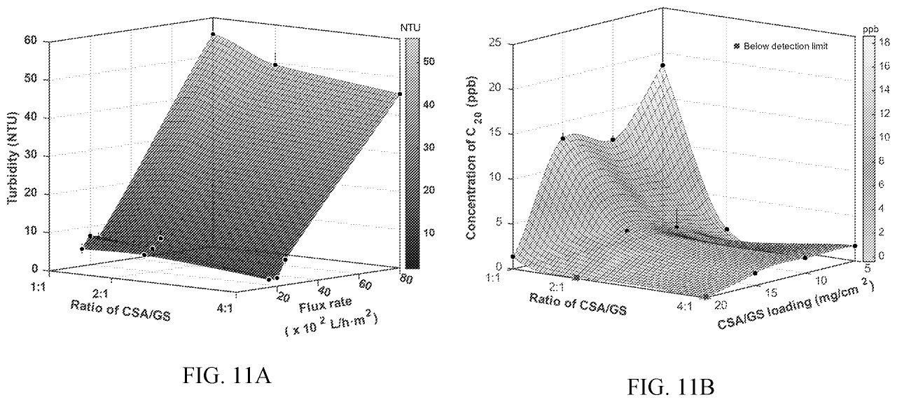

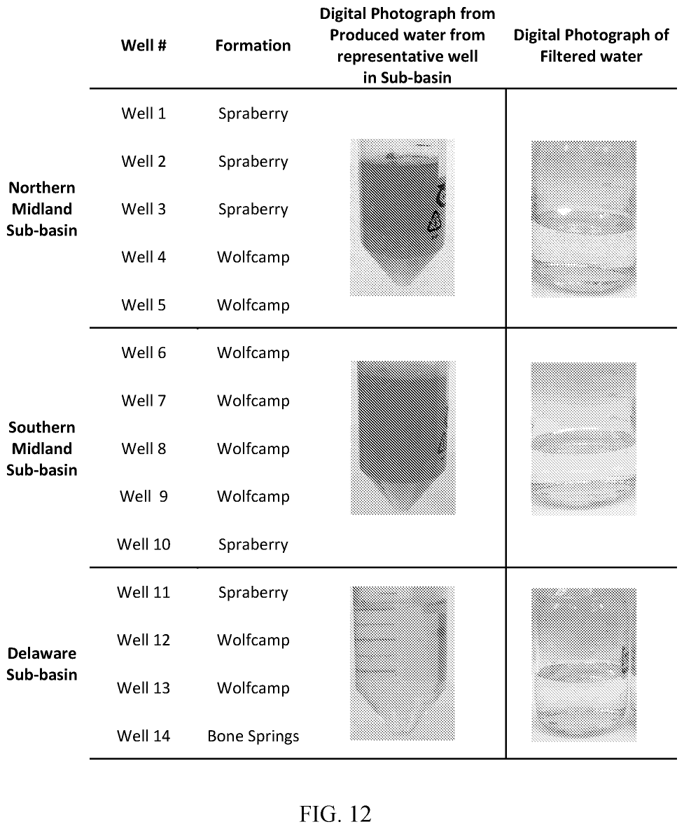

FIG. 2 illustrates the porous network that is stabilized with nanotexturation derived from arrays of ettringite needles formed upon hydration (FIG. 1). During the hydration of CSA cement, hexacalcium aluminate trisulfate hydrate (“ettringite”) and aluminum hydroxide are formed as the primary hydration products. The growth of a crystalline network of needle-like crystals is observed almost immediately upon exposing CSA cement to water. The microporosity of the surface is defined by the spacing between the ettringite needles and hydrated CSA matrix. The workflow sketched in FIG. 1 can be readily tuned to control pore dimensions and thickness, enabling the systematic evaluation of trade-offs between flux rate and selectivity while ensuring mechanical resilience. FIG. 2 shows representative scanning electron microscopy (SEM) images of substrates illustrating the porous microstructures obtained for varying proportions of CSA to glass spheres at different coating thicknesses. The glass spheres embedded in the CSA matrix range in size from 9-13 μm and are spray-coated onto stainless steel meshes, which have pore dimensions of 5 μm×5 μm, as illustrated in FIG. 2, Panels A-C. The weight proportions of CSA and glass beads have been altered to systematically vary the porosity of the coating microstructure, and thus the effective tortuosity of the membranes (FIG. 2, Panels D, G, J); furthermore, the total loading of CSA and glass beads has been varied to control the coating thickness, as illustrated by the cross-sectional SEM images in FIG. 2, Panels F, I, and L. At a CSA:glass sphere weight ratio of 4:1 and a total loading of 20 mg/cm², the dimensions of the porous network are highly constricted and the 3D pore structure allows for considerable interfacial interactions. Substantial 3D texturation as well as tortuosity is evident in FIG. 2, Panels E, H, and K. With an increase in total loading from 5-20 mg/cm², the coating thickness increases from 55±10 μm to 207±35 μm.

American Society for Testing Material (ASTM) D2197 scrape adhesion testing has been performed for the CSA/GS coatings and yield a rating of 100 g upon hydration for 24 h and 150-200 g upon hydration for 28 days.

### Example 2

Power X-ray diffraction (XRD) patterns have been acquired to follow the hydration of CSA coatings within the membrane architectures (FIG. 3A). After approximately 1 h, a fifth major phase appears in the XRD pattern that can be distinguished from the original components (calcium sulfoaluminate, calcium sulfate dihydrate, dicalcium silicate, calcium sulfate hemihydrate), and is indexed to hexacalcium aluminate trisulfate hydrate, designated as “ettringite” (the 214 reflection of ettringite is indicated by an asterisk in FIG. 3A). Pawley fits have been used to evaluate the phase fractions with respect to the major refined phase, calcium sulfoaluminate, ye'elimite, and are listed in Table 1.

The CSA coatings have been further examined by Ca L-edge XANES spectroscopy, which is compared to a CaO standard (FIG. 3B). The coordination of Ca in tricalcium aluminate (3CaO·Al₂O₃) can be cubic or orthorhombic, whereas Ca is coordinated octahedrally in CSA hydrates such as kuzelite, gypsum, and ettringite (Geng et al., 2017). The measured XANES spectra are characterized by four prominent features. The doublets at Ca L_{III}- and Ca L_{II}-edges correspond to transitions from filled 2p_{3/2} and 2p_{1/2} core levels to unfilled states in the conduction band (Bae et al., 2016). Specifically, the doublets at the Ca L_{III}- and Ca L_{II}-edge arise from an asymmetric coordination environment present around the Ca²⁺-ion. The doublets a₁ and a₂ at the Ca L_{III}-edge and a₃ and a₄ at Ca L_{II}-edge are ascribed to transitions into unoccupied states at the conduction band edge with t_{2g} and e_{g} symmetry. The t_{2g} states comprise contributions from empty 3d_{xy}, 3d_{xy}, and 3d_{xz} whereas the e_{g} states include contributions from 3d_{z2} and d_{x2-y2} states. The relative energy positioning of these states is correlated with the strength of Ca-anion bonding, therefore t_{2g} state is at higher energy than the e_{g} state when Ca is in cubic coordination and e_{g} state is at higher energy than the t_{2g} for octahedrally coordinated Ca. The Ca L-edge XANES spectrum of ettringite is similar to that of octahedrally coordinated Ca; the energy separation of c.a. 1.2 eV between a₁-a₂ and a₃-a₄ doublets is furthermore consistent with previous analyses of ettringite (Rajendran et al., 2013). The results provide corroboration for the ettringite crystal structure being an accurate depiction of the local structure of calcium species.

O K-edge XANES spectra have further been acquired and are compared to spectra measured for CaO and Al₂(SO₄)₃ standards as shown in FIG. 3C. In the ettringite samples, several crystallographically inequivalent oxygen atoms are bonded in a multitude of chemical environments to S, Ca, and Al atoms. The different oxygen coordination environments yield a complex electronic structure which is manifested as multiple spectroscopic features in O K-edge XANES spectra. These spectroscopic features as shown in FIG. 3C can be broadly divided into two categories. The features from 530-536 eV can be attributed to electronic excitations from O is core-levels to π* states (O 1s-π*, such as Al—O and S—O hybrid states in Al₂(SO₄)₃), whereas the broad features starting around 537 eV can be assigned to the electronic transitions of O is core-level electrons to electronic states with a δ* character (e.g., S—O δ*electronic states in Al₂(SO₄)₃) (Frati et al., 2020; Henderson et al., 2009). Using CaO and Al₂(SO₄)₃O K-edge XANES spectra as standards, the major spectroscopic features observed in the O K-edge XANES spectrum of (Ca₆Al₂(SO₄)₃(OH)₁₂·26H₂O) can be duly assigned. The feature labeled c′₁ derives from the excitation of O is core-level electrons to S—O and Al—O states with a π* character. The increased intensity of this feature with respect to Al₂(SO₄)₃ can be rationalized based on the presence of [Al(OH)₆]³⁻ polyhedral units in the ettringite structure (Goetz-Neunhoeffer and Neubauer, 2006). The feature at 534.7 eV is attributed to electronic excitations into Ca—O π* states. The feature labeled c′₂ arises from the excitation of Ols core-level electrons to Al—O and S—O δ*electronic states. The broad feature at 540.8 eV can be attributed to the excitation of core-level electrons to δ* states resulting from Ca—O interactions. Overall, all four ettringite samples show similar spectroscopic features; therefore, both the Ca L-edge and O K-edge local structure probes provide evidence for ettringite formation across the four representative samples. Ca L- and O K-edge spectra for ettringite samples after 1, 7, 17, and 28 days show similar spectroscopic features, which attest to the early setting of ettringite, with scarce little modification of the coordination environment after 1 day.

The wettability of the CSA-based membranes has been measured by adapting a pendant drop-deposition method for liquid-submerged low-energy surfaces (Waghmare et al., 2013). In this approach, a low-energy substrate is submerged in a water-filled cuvette; a drop of oil is dispensed onto the submerged substrate using a needle. Contact angles are measured after allowing the oil droplets to settle on the surface. FIGS. 3D and 3E depict contact angle measurements for synthetic engine oil (SAE viscosity grade 5W-40) droplets on bare stainless-steel mesh substrate (pore size of 5 μm) and a CSA/glass-sphere-coated membrane. As a result of the 3D texturation evidenced in FIG. 2, the coated membrane surface exhibits an oil contact angle of 165±3°, unambiguously within a superoleophobic regime. The textured composite membranes exhibit a distinctive combination of underwater superhydrophilic and superoleophobic character, which we have sought to exploit to separate oil-in-water emulsions.

### Example 4

A membrane module as sketched in FIG. 7 was used for PW deoiling and desilting. CSA/glass-sphere-coated stainless steel mesh membranes are sandwiched between stainless-steel sweep and feed flow plates. The PW flows through the system at flux rates controlled by a peristaltic pump. We have evaluated the separation performance of the CSA-based membrane for PW collected from 14 wells from the Permian Basin. FIG. 12 displays the separation performance for each of the collected samples. Clear evidence for desilting is observed even at a flux rate of 1600 L/h·m². A systematic evaluation of membrane performance as a function of coating thickness and porosity has been performed using PW sampled from Well 9, in the Southern Midland region. Gas-chromatography-mass spectrometry and turbidity measurements have been used to evaluate the efficacy of separation achieved by coated membranes in deoiling and desilting, respectively. Table 2 shows the oil fractions detected in PW from Well 9 along with their corresponding retention times and molecular weight. The detected hydrocarbon fractions range from C11 to C30, with molecular weights ranging from 156 to 453 g/mol. Membrane architectures with different weight ratios of CSA cement and GS (4:1, 2:1, 1:1), as well as different overall loadings of CSA/GS (5, 10, 15, and 20 mg/cm²; correlated to coating thickness), have been evaluated for their efficacy in desilting and deoiling PW. FIG. 4 contrasts chromatograms for PW obtained from Well 9, alongside chromatograms for permeates filtered through membranes with three representative coating formulations and thicknesses. Increasing the overall CSA/GS loading engenders greater tortuosity (as demonstrated in FIG. 2), resulting in a substantial diminution of oil in the filtered samples. Indeed, at a CSA/GS ratio of 4:1 and total loading of 20 mg/cm², no hydrocarbons are observed in the filtered stream within instrumental detection limits.

Detailed quantitative analyses of oil content in the filtered water has been performed for membrane formulations systematically varying the coating thickness and weight ratio of CSA to glass spheres. Calibration curves illustrated in FIG. 9 were utilized to determine the concentration of hydrocarbons present in the PW and filtered water samples. Table 3 in the Supplemental Information summarizes the oil concentrations (in ppb) alongside with their corresponding separation efficiency for the most abundant hydrocarbon fractions detected in the filtered water for each coating formulation.

At a CSA/GS loading of 5 mg/cm², the highest detectable oil concentration was 18.30±0.09 ppb (from C22), which corresponds to a separation efficiency of 41.0% for a CSA/GS weight ratio of 1:1. In contrast, increasing the proportion of CSA to 4:1 result in an oil concentration of only ca. 1.40±0.02 ppb in the permeate (from C23), which represents a 94.5% separation efficiency. At a CSA/GS loading of 10 mg/cm², the highest detectable oil concentration was 26.40±0.40 ppb (from C22), rendering a separation efficiency of 14.9%, and the lowest was 1.45±0.07 ppb (from C23) with a 94.3% of separation efficiency when the CSA content was increased in the weight ratio of 4:1. The rise in CSA concentration promoted the approximately 79% increase in the separation efficiency in the individual hydrocarbon fractions. At a CSA/GS loading of 15 mg/cm², the highest detectable oil concentration was 18.31±6.76 ppb (from C22), rendering a separation efficiency of 40.9%, and the lowest was 1.24±0.01 ppb (from C22) with a 96.0% of separation efficiency. Nearly 55% increase was observed with an increase in CSA concentration. At a CSA/GS loading of 20 mg/cm², the highest detectable oil concentration was 1.43±0.003 ppb (from C18), rendering a separation efficiency of 96.7%, and the lowest was 1.28±0.03 ppb (from C13) with a 98.8% of separation efficiency. Moreover, as the loading of CSA/GS is increased, corresponding to increasing coating thickness, the concentration of oil in the permeate is successively decreased, and an increasing number of hydrocarbon fractions are undetectable (see also Table 3). At a total CSA/GS loading of 20 mg/cm² and weight ratios of CSA/GS of 2:1 and 4:1, the only detectable oil fraction corresponds to C13 (MW of 184 g/mol, Table 2). For each of the membrane architectures evaluated, we determined the overall separation efficiency (depicted in FIG. 5A and determined using Equations 1-3 in the Materials and Methods section) considering the concentration of oil for all the aliphatic hydrocarbon fractions present in the PW samples in comparison to the filtrated water samples. The total separation efficiency parameter was correlated to the CSA/GS total loading and CSA/GS weight ratios. The total separation efficiency for total CSA/GS loading of 20 mg/cm² at CSA/GS ratios of 2:1 and 4:1 was both 99.7±0.01%. These results have allowed us to converge on 20 mg/cm² CSA/GS total loadings at CSA/GS ratios of 2:1 and 4:1 as the most optimal coatings for deoiling of PW. A control experiment has been performed using a coating solely comprising CSA without any glass beads. Table 4 tabulates measured oil concentrations in the permeate detected after single-pass filtration of 0.5 and 1 L of PW. It is clear that the composite membrane incorporating glass spheres shows appreciably better performance for different hydrocarbon fractions. The glass spheres add to the 3D texturation of the membrane as observed in FIG. 2 and thus play a pivotal role in enhancing oil removal. FIG. 5A shows that with increasing CSA content in the formulation, there is an increase in separation (deoiling) efficiency.

The flux rate represents a key parameter in membrane separation technologies (O'Loughlin et al., 2018). Flux-rate-dependent separation analyses (FIG. 5B) have been performed for optimal membrane module (CSA/GS ratio of 4:1, CSA/GS loading of 20 mg/cm²) at flux rates ranging from 1600 to 8000 L/h·m². Flux rates below 1600 L/h·m² were not evaluated due to the unsteady flow observed, which was not suitable for rapid cleaning within membrane modules. With increasing flux rate from 2000 to 8000 L/h·m², FIG. 5B shows increasing concentrations of C13 to C27 hydrocarbons in the permeate. At the lower flux rate (i.e., 1600 L/h·m²), the only hydrocarbon fraction detected for optimal membrane module (CSA/GS ratio of 4:1, CSA/GS loading of 20 mg/cm²) was C13, which furthermore appears at a very low intensity in the chromatogram. As such, the optimal flux rate has been found to be 1600 L/h·m², which corresponds to a value of ca. 10,000 gal/day·m². As such, the membrane module offers the potential to clean large volumes of PW generated each day as necessary for industrial applications.

FIGS. 10A-10C exhibit the results of turbidity measurements as a function of CSA/GS loading for membranes with different CSA/GS ratios, 1:1, 2:1, and 4:1, at varying flux rates. FIG. 11A abstracts these results and plots turbidity as a function of the CSA/GS weight ratio and flux rate. At a constant CSA/GS weight ratio, the turbidity of the permeate decreases with decreasing flow rate. At a constant flux rate, the turbidity decreases with the amount of CSA. As such, optimal desilting is obtained at a flux rate of 1600 L/h·m² and high CSA content, corresponding to a CSA/GS weight ratio of 4:1. This also corresponds to optimal conditions for deoiling as shown in FIG. 11B. This comprehensive analysis allows us to converge on a CSA coating with a relatively higher CSA to GS ratio and overall loading for optimal performance in desilting and deoiling of PW. High overall loadings translate to greater membrane tortuosities, with opportunities for retention of silt particles and rejection of oil droplets at the superoleophobic and hydrophilic solid/liquid interface. Under these membrane conditions, the oil content in the filtered water is decreased to as low as 1 ppb with an overall separation efficiency of 99.7%, and indeed several oil fractions from C14 to C23 (MW of 198-324 g/mol) are no longer detectable in the permeate at single pass filtration.

FIGS. 6A and 6B contrast optical microscopy images of PW from Well 9 and filtered water collected from the optimal membrane module with a CSA/GS ratio of 4:1 and a CSA/GS loading of 20 mg/cm². In FIG. 6A, oil droplets and silt particles are clearly visible within the continuous aqueous phase. FIG. 6B shows that these no longer discernible in the filtered permeate. FIG. 6C provides a direct comparison of GC-MS results for Well 9 and the filtered water collected after passing through a membrane module with the abovementioned optimal coating. No C11-C30 hydrocarbons are observable within instrumental detection limits. In addition to the sharp decrease in the concentration of silt particles measured by turbidimetry, particle size analysis has further been performed to examine the dimensions of permeated particles (FIG. 6D). While the particle size distribution is centered around 7.55 μm in PW, the average particle size in the permeate is much smaller at 3.22 μm reflecting the retention of relatively larger particles on the membrane surface.

FIGS. 8A and 8B show digital photographs of a membrane with the optimal coating formulation before and after filtration of 0.5 L of PW. Silt and oil are collected at the surface. The coated membrane is able to sustain 10 cycles of backwashing with little to no degradation of the coating under operational conditions (FIGS. 8C and 8D). FIG. 6E shows the separation efficiency measured through 10 cycles for the membrane with CSA/GS ratio of 4:1, CSA/GS loading of 20 mg/cm². In each cycle, 50 mL of PW water were passed through the membrane module and backwashing was conducted with ca. 5 mL of clean water to remove the retained silt and oil. No additional chemicals were added during the backwashing cycles. The separation efficiency remains constant at ca. 99% within measurement error across the 10 cycles. FIGS. 8C and 8D depict the membrane surface and residue after the first and tenth cycle. The membrane architecture is retained without traces of delamination and with no loss of separation efficiency.

As such, the membrane modules developed here based on low-cost and earth-abundant materials show exceptional performance for separation of recalcitrant emulsions without any pre-treatment and afford an intriguing combinational of mechanical resilience under high pressures, sustain high flow rates compatible with industrial operation, and demonstrate exceptional selectivity. A clear correlation is observed between surface texturation, tortuosity, interfacial wettability, and separation performance in the separation of complex emulsions stabilized by endogenous surfactants.

TABLE 1
Refined phase weight fractions relative
to ye'elimite from the Pawley fit

| | | Refined Phase Weight Fractions | | | |
|---|---|---|---|---|---|
| | | Relative to Ye'elimite | | | |
| | | Ye'elimite | Larnite | Bassanite | Gypsum |
| Unhydrated CSA | | 1 | 0.273 | 0.596 | 0.026 |
| 0 | min | 1 | 0.288 | 0.569 | 0.023 |
| 10 | min | 1 | 0.299 | 0.031 | 0.022 |
| 30 | min | 1 | 0.281 | 0.031 | 0.039 |
| 1 | h | 1 | 0.315 | 0.027 | 0.055 |
| 3 | h | 1 | 0.230 | 0.029 | 0.001 |
| 6 | h | 1 | 0.157 | 0.025 | 0.039 |
| 12 | h | 1 | 0.080 | 0.032 | 0.052 |
| 24 | h | 1 | 0.053 | 0.033 | 0.053 |
| 48 | h | 1 | 0.065 | 0.036 | 0.089 |

TABLE 2
List of oil fractions detected in the samples from the Permian Basin
with the corresponding retention times and molecular weight

| | Retention time | Molecular weight |
|---|---|---|
| Oil fraction | (min) | (g/mol) |
| C11 | 8.410 ± 0.010 | 156 |
| C12 | 9.985 ± 0.005 | 170 |
| C13 | 11.445 ± 0.005 | 184 |
| C14 | 12.800 ± 0.000 | 198 |
| C15 | 14.080 ± 0.000 | 212 |
| C16 | 15.270 ± 0.010 | 226 |
| C17 | 16.420 ± 0.000 | 240 |
| C18 | 17.505 ± 0.005 | 254 |
| C19 | 18.540 ± 0.010 | 268 |
| C20 | 19.530 ± 0.010 | 282 |
| C21 | 20.470 ± 0.010 | 296 |
| C22 | 21.375 ± 0.015 | 310 |
| C23 | 22.245 ± 0.015 | 324 |
| C24 | 23.080 ± 0.010 | 338 |
| C25 | 23.885 ± 0.015 | 352 |
| C26 | 24.655 ± 0.015 | 366 |
| C27 | 25.405 ± 0.015 | 380 |
| C28 | 26.130 ± 0.010 | 394 |
| C29 | 26.825 ± 0.015 | 408 |
| C30 | 27.505 ± 0.015 | 453 |

TABLE 3
Concentration of oil (in ppb) remaining for the distinct oil fractions
evaluated from Well 9 after separation using coated membranes
with different CSA/GS formulations and total loading.

| Total | | Concentration (ng/mL = pbb) (Efficiency (%)) | | | | |
|---|---|---|---|---|---|---|
| loading | Aliphatic | Ratio of CSA/GS | | | | |
| (mg/cm²) | hydrocarbon | 1:1 | | 2:1 | 4:1 | |
| 5 | C13 | 1.49 ± 0.25 | (98.6) | 1.45 ± 0.13 (98.6) | 1.57 ± 0.09 | (98.5) |
| | C14 | 1.61 ± 0.11 | (98.7) | 1.32 ± 0.03 (99.0) | 1.57 ± 0.01 | (98.8) |
| | C16 | 4.77 ± 0.71 | (94.3) | 1.45 ± 0.03 (98.3) | 1.70 ± 0.03 | (98.0) |
| | C18 | 6.94 ± 0.61 | (83.8) | 1.44 ± 0.01 (96.6) | 1.68 ± 0.0004 | (96.1) |
| | C20 | 18.60 ± 2.66 | (54.5) | 1.39 ± 0.03 (96.6) | 1.67 ± 0.01 | (95.9) |
| | C21 | 16.80 ± 1.72 | (47.8) | ND | 1.62 ± 0.003 | (95.0) |
| | C22 | 18.30 ± 0.09 | (41.0) | 1.23 ± 0.03 (96.0) | 1.44 ± 0.04 | (95.3) |
| | C23 | 14.96 ± 0.58 | (40.9) | ND | 1.40 ± 0.02 | (94.5) |
| 10 | C13 | 2.89 ± 0.12 | (97.3) | 2.59 ± 1.71 (97.6) | 1.87 ± 0.12 | (98.3) |
| | C14 | 3.43 ± 0.15 | (97.3) | 2.96 ± 2.32 (97.7) | 1.66 ± 0.13 | (98.7) |
| | C16 | 6.13 ± 0.22 | (92.7) | 4.42 ± 4.53 (94.7) | 1.76 ± 0.11 | (97.9) |
| | C18 | 6.48 ± 0.55 | (84.9) | 2.68 ± 1.78 (93.8) | 1.72 ± 0.03 | (96.0) |
| | C20 | 11.67 ± 0.54 | (71.4) | 2.97 ± 2.20 (92.7) | 1.71 ± 0.08 | (95.8) |
| | C21 | 9.46 ± 1.28 | (70.6) | 2.93 ± 2.12 (90.9) | 1.65 ± 0.04 | (94.9) |
| | C22 | 26.40 ± 0.40 | (14.9) | 2.67 ± 2.03 (91.4) | 1.50 ± 0.06 | (95.2) |
| | C23 | 11.60 ± 4.36 | (54.2) | 2.61 ± 1.97 (89.7) | 1.45 ± 0.07 | (94.3) |
| 15 | C13 | 6.21 ± 0.63 | (94.2) | 2.66 ± 0.34 (97.5) | 1.56 ± 0.04 | (98.5) |
| | C14 | 7.45 ± 0.45 | (94.1) | 2.87 ± 0.10 (97.7) | ND | |
| | C16 | 8.09 ± 0.18 | (90.3) | 2.80 ± 0.15 (96.7) | 1.45 ± 0.01 | (98.3) |
| | C18 | 7.95 ± 0.29 | (81.5) | 3.58 ± 0.18 (91.7) | ND | |
| | C20 | 13.18 ± 0.62 | (67.8) | 3.96 ± 0.20 (90.3) | 1.37 ± 0.02 | (96.6) |
| | C21 | 12.52 ± 1.75 | (61.1) | 2.60 ± 0.14 (88.8) | 1.40 ± 0.02 | (95.6) |
| | C22 | 18.31 ± 6.76 | (40.9) | 3.23 ± 0.22 (89.6) | 1.24 ± 0.01 | (96.0) |
| | C23 | 12.03 ± 0.44 | (52.5) | 3.00 ± 0.16 (88.1) | ND | |
| 20 | C13 | 1.28 ± 0.03 | (98.8) | 1.42 ± 0.12 (98.7) | 1.34 ± 0.07 | (98.7) |

| | | | | |
|---|---|---|---|---|
| C14 | 1.40 ± 0.13 | (98.9) | | |
| C16 | 1.44 ± 0.01 | (98.3) | | |
| C18 | 1.43 ± 0.004 | (96.7) | | |
| C20 | 1.38 ± 0.02 | (96.6) | Not detected | Not detected |

| | |
|---|---|
| C21 | |
| C22 | Not detected |
| C23 | |

*Fearturing the most abundant fractions from C13 to C23.

TABLE 4
Comparison of the separation efficiency (in terms of oil concentration
remaining after separation) of CSA-based membranes and CSA only
substrate through the differences in oil concentrations (in ppb)
for the different oil fractions in Well 9 after separation.

| | Concentration of different aliphatic hydrocarbons | | | | |
|---|---|---|---|---|---|
| | in produced water and filtrate (ppb) | | | | |
| | Well 9 - | | | | |
| | Produced | CSA/GS 4:1/20 mg/cm² | | CSA only | |
| | water | After 0.5 L | After 1 L | After 0.5 L | After 1 L |
| C13 | 75.27 ± 44.58 | 1.31 ± 0.02 | 1.32 ± 0.02 | 2.41 ± 0.07 | 1.62 ± 0.04 |
| C14 | 85.99 ± 57.07 | 1.31 ± 0.01 | 1.34 ± 0.01 | 2.39 ± 0.11 | 1.63 ± 0.02 |
| C16 | 60.21 ± 33.25 | 1.45 ± 0.01 | 1.47 ± 0.01 | 2.16 ± 0.06 | 1.66 ± 0.02 |
| C18 | 27.76 ± 21.43 | 1.45 ± 0.01 | 1.45 ± 0.01 | 1.84 ± 0.03 | 1.5 ± 0.01 |
| C20 | 30.85 ± 14.2 | 1.39 ± 0.03 | 1.39 ± 0.01 | 1.69 ± 0.02 | 1.47 ± 0.01 |
| C21 | 26.78 ± 7.66 | 1.41 ± 0.03 | 1.4 ± 0.02 | 1.63 ± 0.02 | 1.47 ± 0.01 |
| C22 | 24.55 ± 9.15 | ND | ND | 1.38 ± 0.01 | 1.28 ± 0.01 |
| C23 | 21.02 ± 6.08 | 1.23 ± 0.01 | ND | 1.35 ± 0.01 | 1.27 ± 0.01 |

*Featuring the most abundant fractions from C13 to C23.

### REFERENCES

Babayev, M., Du, H., Botlaguduru, V. S. V. & Kommalapati, R. R. (2019). Zwitterion-Modified Ultrafiltration Membranes for Permian Basin Produced Water Pretreatment. Water, 11, 1710.
Bae, S., Kanematsu, M., Hernández-Cruz, D., Moon, J., Kilcoyne, D. & Monteiro, P. J. M. (2016). In Situ Soft X-ray Spectromicroscopy of Early Tricalcium Silicate Hydration. Materials, 9, 976.
Bajpayee, A., Alivio, T. E. G., McKay, P. & Banerjee, S. (2019). Functionalized Tetrapodal ZnO Membranes Exhibiting Superoleophobic and Superhydrophilic Character for Water/Oil Separation Based on Differential Wettability. Energy Fuels, 33, 5024-5034.
Bolto, B., Zhang, J., Wu, X. & Xie, Z. (2020). A Review on Current Development of Membranes for Oil Removal from Wastewaters. Membranes, 10, 65.
Cai, Y., Shi, S. Q., Fang, Z. & Li, J. (2021). Design, Development, and Outlook of Superwettability Membranes in Oil/Water Emulsions Separation. Adv. Mater. Interfaces, 8, 2100799.
Chen, T., Duan, M. & Fang, S. (2016). Fabrication of novel superhydrophilic and underwater superoleophobic hierarchically structured ceramic membrane and its separation performance of oily wastewater. Ceram. Int., 42, 8604-8612.
Cooper, C. M., McCall, J., Stokes, S. C., McKay, C., Bentley, M. J., Rosenblum, J. S., Blewett, T. A., Huang, Z., Miara, A., Talmadge, M., Evans, A., Sitterley, K. A., Kurup, P., Stokes-Draut, J. R., Macknick, J., Borch, T., Cath, T. Y. & Katz, L. E. (2021). Oil and Gas Produced Water Reuse: Opportunities, Treatment Needs, and Challenges. ACS ES&T Eng.
Dickhout, J. M., Moreno, J., Biesheuvel, P. M., Boels, L., Lammertink, R. G. H. & de Vos, W. M. (2017). Produced water treatment by membranes: A review from a colloidal perspective. J. Colloid Interface Sci., 487, 523-534.
Douglas, L. D., Rivera-Gonzalez, N., Cool, N., Bajpayee, A., Udayakantha, M., Liu, G.-W., Anita & Banerjee, S. (2022). A Materials Science Perspective of Midstream Challenges in the Utilization of Heavy Crude Oil. ACS Omega.
EIA (2021). Drilling Productivity Report. In: ADMINISTRATION, U. S. E. I. (ed.) Permian Region.
Fakhru'l-Razi, A., Pendashteh, A., Abdullah, L. C., Biak, D. R. A., Madaeni, S. S. & Abidin, Z. Z. (2009). Review of technologies for oil and gas produced water treatment. J. Hazard. Mater., 170, 530-551.
Frati, F., Hunault, M. O. J. Y. & de Groot, F. M. F. (2020). Oxygen K-edge X-ray Absorption Spectra. Chem. Rev., 120, 4056-4110.
Geng, G., Myers, R. J., Kilcoyne, A. L. D., Ha, J. & Monteiro, P. J. M. (2017). Ca L2,3-edge near edge X-ray absorption fine structure of tricalcium aluminate, gypsum, and calcium (sulfo)aluminate hydrates. Am. Mineral., 102, 900-908.
Goetz-Neunhoeffer, F. & Neubauer, J. (2006). Refined ettringite (Ca6Al2(SO4)3(OH)12·26H2O) structure for quantitative X-ray diffraction analysis. Powder Diffr., 21, 4-11.
Hargis, C. W., Telesca, A. & Monteiro, P. J. M. (2014). Calcium sulfoaluminate (Ye'elimite) hydration in the presence of gypsum, calcite, and vaterite. Cem. Concr. Res., 65, 15-20.
Henderson, G. S., Neuville, D. R. & Cormier, L. (2009). An O K-edge XANES study of glasses and crystals in the CaO·Al2O3-SiO2 (CAS) system. Chem. Geol., 259, 54-62.
Hussain, F. A., Zamora, J., Ferrer, I. M., Kinyua, M. & Velázquez, J. M. (2020). Adsorption of crude oil from crude oil-water emulsion by mesoporous hafnium oxide ceramics. Environ. Sci. Water Res. Technol., 6, 2035-2042.
Igunnu, E. T. & Chen, G. Z. (2012). Produced water treatment technologies. Int. J. Low-Carbon Technol., 9, 157-177.
Jimenez, S., Micó, M. M., Arnaldos, M., Medina, F. & Contreras, S. (2018). State of the art of produced water treatment. Chemosphere, 192, 186-208.
Liu, L., Chen, C., Yang, S., Xie, H., Gong, M. & Xu, X. (2016). Fabrication of superhydrophilic-underwater superoleophobic inorganic anti-corrosive membranes for high-efficiency oil/water separation. Phys. Chem. Chem. Phys., 18, 1317-1325.
Mercelat, A. Y., Cooper, C. M., Kinney, K. A., Seibert, F. & Katz, L. E. (2021). Mechanisms for Direct Separation of Oil from Water with Hydrophobic Hollow Fiber Membrane Contactors. ACS ES&T Eng., 1, 1074-1083.
Molecule Works Inc. (2020). Miniature filter and separator design (MemXcel) [Online]. Available: https://moleculeworks.com/device [Accessed November 2021].
Neff, J. M., Lee, K. & DeBlois, E. M. (Year) Published. Produced Water: Overview of Composition, Fates, and Effects. 2011.
O'Loughlin, T. E., Martens, S., Ren, S. R., McKay, P. & Banerjee, S. (2017). Orthogonal Wettability of Hierarchically Textured Metal Meshes as a Means of Separating Water/Oil Emulsions Adv. Eng. Mater., 19, 1600808.
O'Loughlin, T. E., Ngamassi, F.-E., McKay, P. & Banerjee, S. (2018). Separation of Viscous Oil Emulsions Using Three-Dimensional Nanotetrapodal ZnO Membranes. Energy Fuels, 32, 4894-4902.
Olajire, Abass A. (2020). Recent advances on the treatment technology of oil and gas produced water for sustainable energy industry-mechanistic aspects and process chemistry perspectives. Chem. Eng. J. Adv., 4, 100049.
Padaki, M., Surya Murali, R., Abdullah, M. S., Misdan, N., Moslehyani, A., Kassim, M. A., Hilal, N. & Ismail, A. F. (2015). Membrane technology enhancement in oil-water separation. A review. Desalination, 357, 197-207.
Rajendran, J., Gialanella, S. & Aswath, P. B. (2013). XANES analysis of dried and calcined bones. Mater. Sci. Eng. C., 33, 3968-3979.
Rodriguez, A. Z., Wang, H., Hu, L., Zhang, Y. & Xu, P. (2020). Treatment of Produced Water in the Permian Basin for Hydraulic Fracturing: Comparison of Different Coagulation Processes and Innovative Filter Media. Water, 12, 770.
Scanlon, B. R., Ikonnikova, S., Yang, Q. & Reedy, R. C. (2020a). Will Water Issues Constrain Oil and Gas Production in the United States? Environ. Sci. Technol., 54, 3510-3519.
Scanlon, B. R., Reedy, R. C., Male, F. & Walsh, M. (2017). Water Issues Related to Transitioning from Conventional to Unconventional Oil Production in the Permian Basin. Environ. Sci. Technol., 51, 10903-10912.
Scanlon, B. R., Reedy, R. C. & Wolaver, B. D. (2021). Assessing cumulative water impacts from shale oil and gas production: Permian Basin case study. Sci. Total Environ., 152306.
Scanlon, B. R., Reedy, R. C., Xu, P., Engle, M., Nicot, J. P., Yoxtheimer, D., Yang, Q. & Ikonnikova, S. (2020b). Can we beneficially reuse produced water from oil and gas extraction in the U.S.? Sci. Total Environ., 717, 137085.
Waghmare, P. R., Das, S. & Mitra, S. K. (2013). Drop deposition on under-liquid low energy surfaces. Soft Matter, 9, 7437-7447.
Wang, H. (2020). The economic impact of oil and gas development in the Permian Basin: Local and spillover effects. Resour. Policy, 66, 101599.
Wang, H. (2021). Shale oil production and groundwater: What can we learn from produced water data? PLOS ONE, 16, e0250791.
Zarghami, S., Mohammadi, T., Sadrzadeh, M. & Van der Bruggen, B. (2019). Superhydrophilic and underwater superoleophobic membranes—A review of synthesis methods. Prog. Polym. Sci., 98, 101166.
Zhou, Q., Milestone, N. B. & Hayes, M. (2006). An alternative to Portland Cement for waste encapsulation—The calcium sulfoaluminate cement system. J. Hazard. Mater., 136, 120-129.
Zolghadr, E., Firouzjaei, M. D., Amouzandeh, G., LeClair, P. & Elliott, M. (2021). The Role of Membrane-Based Technologies in Environmental Treatment and Reuse of Produced Water. Front. Environ. Sci., 9.
Zoubeik, M., Salama, A. & Henni, A. (2019). A comprehensive experimental and artificial network investigation of the performance of an ultrafiltration titanium dioxide ceramic membrane: application in produced water treatment. Water Environ. J., 33, 459-475.

1. The filter membrane comprising a permeable substrate, such as cellulose fibers, fabrics, including, but not limited to cotton fabrics, polyester fabrics, denim fabrics, denim, crinoline, elastane or spandex, viscose, linen, and combinations thereof, Al₂O₃, a metal or metal oxide substrate, a ceramic, a sintered metal, or a metal mesh, coated with a water permeable cement that, optionally, contains, embedded within the cement, solid impermeable structures selected from cubes, cuboids, prisms, pyramids, platonic solids, torus, cone, cylinder, spheres and mixtures thereof.

2-28. (canceled)
